(19) United States
(12) Patent Application Publication
(10) Pub. No.: US 2017/0030198 A1
(43) Pub. Date: Feb. 2, 2017

(54) METHOD FOR COOLING A TURBO-ENGINE COMPONENT AND TURBO-ENGINE COMPONENT

(71) Applicant: ANSALDO ENERGIA IP UK LIMITED, London (GB)

(72) Inventors: Joerg KRÜCKELS, Birmenstorf (CH); Herbert BRANDL, Waldshut-Tiengen (DE)

(73) Assignee: ANSALDO ENERGIA IP UK LIMITED, London (GB)

(21) Appl. No.: 15/223,242

(22) Filed: Jul. 29, 2016

(30) Foreign Application Priority Data
Jul. 29, 2015 (EP) 15178850.2

(51) Int. Cl. F01D 5/18; F01D 25/12; F01D 9/04

(52) U.S. Cl. CPC F01D 5/186; F01D 9/041; F01D 25/12; F05D 2220/32; F05D 2240/30; F05D 2240/12; F05D 2260/201; F05D 2260/202; F05D 2260/2212; F05D 2240/15; F05D 2240/81

(57) ABSTRACT

Disclosed is a turbo-engine component and a method for cooling a turbo-engine component. The method includes guiding a working fluid flow along a hot gas side surface of a wall of the component and in a main working fluid flow direction, discharging a coolant discharge flow at the hot gas side surface from a coolant discharge duct provided in the wall, and supplying a coolant supply flow to the coolant discharge duct and through a coolant supply path. The method also includes discharging the coolant supply flow into the coolant discharge duct as a free jet oriented across a cross section of the coolant discharge duct, and directing the free jet onto an inner surface section of the coolant discharge duct, thus effecting impingement cooling of the inner surface section.

### TECHNICAL FIELD

The present disclosure relates to a method for cooling a turbo-engine component as set forth in claim 1, and a turbo-engine component adapted and configured to perform said method.

### BACKGROUND OF THE DISCLOSURE

It is known in the art to cool thermally loaded components in turbo-engines through so-called film cooling. Typical examples may be found in the expansion turbine of a gas turbine engine, where blades, vanes, platforms and other components in the hot gas path, and in particular in the hot gas path of the first expansion turbine stages, are exposed to a hot gas flow with a temperature exceeding the admissible temperature of the materials used for these components, the more when considering the significant mechanical stresses to which the components are exposed when operating the engine.

In applying film cooling, a layer of relatively cooler fluid is provided flowing along the surfaces of the components which are exposed to a hot working fluid flow.

To provide the film cooling fluid on the component surface, ducts are provided in walls of the component opening out on a hot gas exposed surface of hot gas exposed walls of the component. Said ducts are inclined with respect to a normal of the hot gas exposed surface, or hot gas side surface, of the wall. The ducts are inclined into the main direction of the working fluid flowing along the component such as to discharge the film cooling fluid with a velocity component parallel to that of the working fluid, and tangential to the hot fluid exposed surface, such that said layer of film cooling fluid is provided. However, by nature the number of film coolant discharge ducts is limited. Downstream the film coolant flow the cooling effect decreases rapidly along the hot gas side surface towards a downstream arranged next coolant discharge duct. Thus, the coolant effect becomes fairly inhomogeneous along the main direction of the working fluid flow, and also across the main direction of the working fluid flow, as also surface sections located lateral of a coolant discharge duct, related to the main direction of the working fluid flow, are poorly cooled. As a result, the cooling of the hot gas exposed surface may become fairly inhomogeneous, and in turn the temperature distribution of a hot gas exposed wall of the component. This may result in local hot spots, and also in thermal stresses, both potentially compromising component service lifetime, or calling for stronger dimensioned components, or both.

Moreover, coolant discharge ducts provided as passages extended between a coolant side of a component wall and the hot gas side surface of a component wall reduce the mechanical strength of the component, and said mechanical strength is reduced the more as a larger number of coolant discharge ducts are provided in the wall. That is, the more cooling is provided to the wall in order to provide for cooling the more is the mechanical strength reduced. Moreover, its needs to be considered that a large number of coolant discharge ducts require a large coolant flow. The overall mass flow of coolant however may have a significant impact on the overall engine efficiency and performance through various effects. The coolant discharged on the hot gas side surface of the wall may have an impact on the working fluid flow field and temperature. The consumption of coolant as such may have a negative impact, if, for instance, the coolant is bled from a compressor of a gas turbine engine. It may thus be desirable to use the coolant as efficient as possible on the one hand, in order to reduce the coolant consumption. It may further be found desirable to provide and arrange the coolant discharge ducts such as to dispense the coolant on the hot gas side surface of a component wall as evenly as possible.

It has thus been proposed in the art, on the one hand, to provide the coolant discharge ducts such that they open out onto the hot gas side of a component wall as slots with a long axis thereof oriented across the main working fluid flow direction in order to provide improved cooling effect across the main working fluid flow direction. It is further known from U.S. Pat. No. 4,726,735 to provide the coolant discharge ducts as blind cavities which do not penetrate the wall and are closed towards a coolant side of the wall. According to US2001/0016162, coolant is supplied to the coolant discharge ducts through coolant supply paths which further comprises a near wall cooling duct arranged downstream the coolant discharge duct, related to the main working fluid flow direction. Thus, counterflow near wall cooling is provided downstream the coolant discharge duct and in areas of the wall disposed between two coolant discharge ducts arranged along the main flow direction of the working fluid.

However, cooling may still be comparatively weak in a wall region delimiting the coolant discharge duct directly upstream the coolant discharge duct, whereas low material strength is provided in said region due to the inclination of the coolant discharge duct.

### LINEOUT OF THE SUBJECT MATTER OF THE PRESENT DISCLOSURE

It is an object of the present disclosure to provide a method for cooling a turbo-engine component and a turbo-engine component adapted and configured to perform the method. In one aspect, improved cooling of the component is to be achieved. In another aspect, effective use of the coolant is to be provided for. In still another aspect, a more even cooling of and in turn temperature distribution in a hot gas exposed component shall be achieved. This in turn serves to save expensive coolant, such as cooling air bled from a compressor in a gas turbine engine. In yet another aspect, effective cooling of a surface delimiting the coolant discharge duct upstream the coolant discharge duct, when considering the main working fluid flow direction, shall be achieved.

Further effects and advantages of the disclosed subject matter, whether explicitly mentioned or not, will become apparent in view of the disclosure provided below.

This is achieved by the subject matter described in claim 1 and in the further independent claims.

Accordingly, disclosed is method for cooling a turbo-engine component, the method comprising guiding a working fluid flow along a hot gas side surface of a wall of the component and in a main working fluid flow direction, discharging a coolant discharge flow at the hot gas side surface from a coolant discharge duct provided in the wall, and supplying a coolant supply flow to the coolant discharge duct and through a coolant supply path. It will be appreciated to this extent that the component is intended for a specific use, and thus the main working fluid flow direction is a well-defined orientation of the component, and/or a hot gas exposed wall thereof, respectively. The component may for instance be a blade, vane, airfoil, platform, heat shield and the like, having an aerodynamic shape and/or fixation means which relate to the intended main working fluid flow direction in a unique manner. The method further comprises discharging the coolant supply flow into the coolant discharge duct as a free jet oriented across a cross section of the coolant discharge duct and directing the free jet onto an inner surface section of the coolant discharge duct, thus effecting impingement cooling of said inner surface section. In effecting impingement cooling of a coolant discharge duct inner surface section, and a respective section of the component wall, cooling at the respective location is considerable improved.

The free jet may according to one aspect of the present disclosure be provided in guiding the coolant supply flow through an appropriate jet generating means, such as a nozzle, and discharging the free jet from said means. Guiding the coolant supply flow through an appropriate means disposed at a junction of the coolant supply path and the coolant discharge duct may serve to accelerate the coolant supply flow in said means and thus to provide a high velocity and high impulse free jet which is particularly well-suited for effecting impingement cooling. Other means for providing the free jet, and, more specifically, for accelerating the coolant supply flow which is directed into the coolant discharge duct, may be applied instead of or in addition to the nozzle. In providing a flow accelerating section of a coolant supply path through which the coolant supply flow is provided, and in particular providing an accelerating section which effects a continuous flow acceleration, such as for instance a nozzle, a more defined and unidirectional free jet flow is achieved, when compared to simple orifices as would be provided by simple metering holes. Impingement cooling efficiency and effectiveness are enhanced and become more predictable.

More specifically, the method may comprise discharging the coolant supply flow into the coolant supply duct at a location which is spaced a certain distance from a blind end, or upstream end with respect to the coolant flow direction within the coolant discharge duct. The coolant flow direction or coolant discharge flow direction may to this extent be defined from the interior of the coolant discharge duct towards a discharge opening through which the coolant is discharged at the hot gas side surface. This enables the impingement cooling free jet to more uniformly disseminate over a surface on which it impinges. A coolant supply opening, or a nozzle, through which the coolant supply flow is discharged into the coolant discharge duct has a size in the coolant flow direction, or, in specific embodiments, a diameter. A lower or upstream edge of said coolant supply opening is spaced from a blind or upstream end of the coolant discharge duct by a distance, which is in certain embodiments larger than or equal to 50% of said coolant supply opening size or diameter, and in still further embodiments larger than or equal to 70% of said coolant supply opening size or diameter. In another aspect, a center of the coolant supply opening, when seen along the coolant flow direction, is spaced apart from the blind or upstream end of the coolant discharge duct by a distance which is larger than or equal to said coolant supply opening size or diameter, and is more particularly larger than or equal to 1.2 times said coolant supply opening size or diameter. Impingement cooling effectiveness is improved.

The method may in another aspect comprise discharging the coolant discharge flow in a direction inclined with respect to a normal of the hot gas side surface at the discharge location, whereby the coolant discharge duct is inclined with respect to said normal, thus having a first inner surface section disposed towards the hot gas side surface of the wall, and directing the free jet onto said first inner surface section. It is understood in this respect that the hot gas side surface may be curved, and the normal chosen as a reference may then be a normal at the respective coolant discharge location on the hot gas side surface. In particular, if the inclination is chosen such that the coolant discharge flow is oriented downstream the main working fluid flow said embodiment supports providing a film cooling layer as described above on the hot gas side surface of the wall. In this respect it may be said the embodiment of the method comprises providing a film cooling layer on the hot gas side surface, and more in particular downstream the coolant discharge opening. In other words, it may be said to perform film cooling of the hot gas side surface of the wall. This is achieved in providing the coolant discharge duct with a respective inclination towards the normal of the hot gas side surface, and/or an appropriate contouring of the coolant discharge ducts at the coolant discharge opening. An abundance of appropriate contours of coolant discharge ducts are known in the art or may become known to the skilled person in the future. However, in inclining the coolant discharge duct, and in turn the coolant discharge flow, accordingly downstream the main working fluid flow direction, a surface delimiting the coolant discharge duct will comprise a section which is disposed towards the hot gas side surface of the wall, and in certain embodiments constitutes a upstream delimiting surface of the coolant discharge duct with respect to the main working fluid flow direction. It may be said that an orientation of the coolant discharge duct from inside the wall to a coolant discharge opening at which the coolant discharge duct opens out onto the hot gas side surface is inclined with respect to the normal. Adjacent said surface section of the inner surface delimiting the coolant discharge duct only a small wall thickness may be present between the delimiting surface of the coolant discharge duct and the hot gas side surface. Moreover, said wall section may not fully benefit from the film cooling layer emanating from the coolant discharge duct, due to an upstream location. This wall section may thus be particularly vulnerable to heat intake from the working fluid flow. A remedy for this situation is provided according to the present disclosure in providing a free jet from the coolant supply path and in directing the free jet of coolant supply fluid onto said inner surface section of the coolant discharge duct and thus effecting impingement cooling of the respective wall section.

In this respect, the method may further comprise providing the free jet in a jet direction having at least one of a velocity component oriented from the coolant side surface of the wall and towards the hot gas side surface of the wall and/or oriented upstream the main working fluid flow direction.

The method may further comprise guiding the coolant supply flow, before discharging it into the coolant discharge duct, inside the wall between a coolant side surface of the wall and the hot gas side surface of the wall, and oriented against the main working fluid flow direction and along a flow path length exceeding a wall thickness provided between the coolant side surface and the hot gas side surface. Said flow path length may exceed the wall thickness in particular by a factor 5 or more, and more in particular by a factor 10 or more. Such, counterflow convective near wall cooling of the wall is performed. In particular the flow path of the coolant supply flow inside the wall is at least essentially parallel to the hot gas side surface.

The method may further comprise discharging a coolant discharge flow at multiple locations along and/or across the main working fluid flow direction, and in particular through independent coolant discharge ducts provided in the wall and opening out onto the hot gas side of the wall at respective multiple discharge locations.

A turbo-engine component is disclosed, comprising a wall, the wall having a hot gas side surface and a coolant side surface, the component comprising at least one coolant discharge duct provided in said wall and opening out onto the hot gas side surface, the component further comprising a coolant supply path in fluid communication with the coolant discharge duct, wherein the coolant discharge duct and the coolant supply path are arranged to perform a method as herein described.

Disclosed is a turbo-engine component comprising a wall, the wall having a hot gas side surface and a coolant side surface, the component further comprising at least one coolant discharge duct provided in said wall and opening out onto the hot gas side surface of the wall, in particular through a coolant discharge opening provided on the hot gas side surface. The coolant discharge duct is delimited by an inner surface thereof. The component further comprises a coolant supply path provided in the wall and in fluid communication with the coolant discharge duct. The coolant supply path joins the coolant discharge duct at a lateral delimiting surface thereof at a nonzero angle. A means for providing a free jet emanating from the coolant supply path and into the coolant discharge duct is provided. Said means may in particularly be provided as a flow accelerating cross section of the coolant supply path provided at or adjacent to the junction of the coolant supply path and the coolant discharge duct. Thus, the flow entering the coolant discharge duct from the coolant supply path is oriented across the coolant discharge duct. In accelerating the fluid supply flow prior to or upon entry into the coolant discharge duct, a high impulse jet is generated across the coolant discharge duct which impinges on a opposed inner surface section of the coolant discharge duct and effects impingement cooling, as described above. The flow accelerating cross section may be shaped as a nozzle provided at the junction of the coolant supply path and the coolant discharge duct. In providing a flow accelerating section of the coolant supply path, and in particular providing an accelerating section which effects a continuous flow acceleration, such as for instance a nozzle, a more defined and unidirectional free jet flow is achieved, when compared to simple orifices as would be provided by simple metering holes. Impingement cooling efficiency and effectiveness are enhanced and become more predictable.

The coolant discharge duct may be provided as a blind cavity in the wall and closed towards the coolant side surface. This may serve to improve mechanical strength and structural integrity of the component in turn to enhance service lifetime. It is enabled in providing the coolant supply path joining the coolant discharge duct at a lateral wall thereof.

In certain exemplary embodiments of the turbo-engine component the coolant supply path joins the coolant discharge duct through an opening provided in a lateral delimiting surface section thereof disposed on a downstream side with respect to a main working fluid flow direction. This supports impingement cooling of an inner wall section of the coolant discharge duct disposed upstream the main working fluid flow direction.

More specifically, the coolant supply path may join the coolant discharge duct at a certain distance from a blind end, or upstream end with respect to the coolant flow direction inside the coolant discharge duct. This enables the impingement cooling free jet emanating from the coolant supply path and into the coolant discharge duct to more uniformly disseminate over a surface on which it impinges. A coolant supply opening, or a nozzle, through which the coolant supply path joins the coolant discharge duct has a size in the coolant flow direction, or, in specific embodiments, a diameter. A lower or upstream edge of said coolant supply opening is spaced from a blind or upstream end of the coolant discharge duct by a distance, which is in certain embodiments larger than or equal to 50% of said coolant supply opening size or diameter, and in still further embodiments larger than or equal to 70% of said coolant supply opening size or diameter. In another aspect, a center of the coolant supply opening, when seen along the coolant flow direction, is spaced apart from the blind or upstream end of the coolant discharge duct by a distance which is larger than or equal to said coolant supply opening size or diameter, and is more particularly larger than or equal to 1.2 times said coolant supply opening size or diameter. Impingement cooling effectiveness is improved.

The coolant discharge duct may be inclined with respect a normal of the hot gas side surface at a first angle, said inclination being directed downstream a main working fluid flow direction of the component when considering an orientation of the coolant discharge duct from inside the wall to a discharge opening provided on the hot gas surface. It may be said that the first angle is located in a plane defined by the main working fluid flow direction and the normal. In another point of view it may be said that an orientation of the coolant discharge duct along or tangential to the hot gas side surface defines the main working fluid flow direction is provided due to the inclination. A direction of the coolant discharge duct may be defined by an axis thereof. In another point of view, an orientation of inner delimiting surfaces of the coolant discharge duct may be said to define said orientation and in turn said inclination. In still another point of view, a mean orientation of inner delimiting surfaces of the coolant discharge duct may be said to define said orientation and in turn said inclination. A lateral delimiting surface of the coolant discharge duct accordingly comprises a first surface section disposed towards the hot gas side surface of the wall and a second surface section disposed towards the coolant side surface of the wall. The coolant supply path joins the coolant discharge duct through an opening provided in the second surface section. An emanating jet of coolant supply fluid accordingly is directed onto the opposed first surface, which in turn is disposed towards the hot gas side surface of the wall.

It may in another respect be said that at the junction of the coolant supply path with the coolant discharge duct the coolant supply path defines a flow direction directed upstream the component main flow direction and towards the hot gas side surface. In another aspect it may be said that a nozzle or any other flow accelerating means disposed at or adjacent to said junction and in the coolant supply path defines a flow direction directed upstream the component main flow direction and towards the hot gas side surface.

In particular, the coolant supply path may be in fluid communication with a coolant supply volume provided adjacent the coolant side surface of the wall such as to provide a coolant flow from said supply volume to the coolant discharge duct.

In still further embodiments of the turbo-engine component according to the present disclosure, the coolant supply path comprises a near wall cooling duct running inside the wall along a lengthwise extent of the wall. A lengthwise extent of the wall is in this respect will be understood as extending between and along, or essentially aligned with, the hot gas side surface of the wall and the coolant side surface of the wall. In certain aspects it may be understood as parallel to at least one of the hot gas side surface and the coolant side surface. In specific aspects it may be understood as extending at least essentially parallel to the main working fluid flow direction. The near wall cooling duct extends from a first end thereof to a second end thereof, wherein the means for providing a free jet, as in particular embodiments a nozzle, is disposed adjacent the second end of the near wall cooling duct, and the first end of the near wall cooling duct is disposed downstream of the second end of the near wall cooling duct with respect to the main working fluid flow direction. As lined out above, by virtue of this embodiment convective counterflow near wall cooling is effected before the coolant supply flow is discharged from the coolant supply path into the coolant discharge duct. The near wall cooling duct, in more specific embodiments, runs at least essentially in parallel to the hot gas side surface.

The internal surfaces of the near wall cooling duct may be shaped such as to improve heat transfer between the surfaces of the near wall cooling duct and the coolant supply flow therethrough, and/or may be equipped with elements enhancing heat transfer. Any means known to the skilled person which intensify heat transfer between the surfaces delimiting the near wall cooling duct and the coolant flow therethrough may be applied, such as, but not limited to, posts connecting opposed surfaces, the inner surfaces of the near wall cooling duct may be undulating, and so forth. In specific embodiments, turbulence generating elements are provided within the near wall cooling duct and on an inner surface thereof.

In still further embodiments of the turbo-engine component according to the present disclosure, a coolant inflow duct is provided extending between the coolant side surface of the wall and the near wall cooling duct and joins the near wall cooling duct at a sidewall thereof, wherein the junction is provided at or adjacent the first end of the near wall cooling duct and is in particular provided on a side of the near wall cooling duct disposed towards the coolant side. It is further conceivable that a free jet generating means similar to that described above at or adjacent to the junction of the coolant supply path and the coolant discharge duct is disposed adjacent to or at the junction of the coolant inflow duct and the near wall cooling duct. In particular in embodiments, where the coolant inflow duct joins the near wall cooling duct at an inner surface section thereof disposed towards the coolant side, the free jet impinges on an opposed inner surface section of the near wall cooling duct which is disposed towards the hot gas side surface. As will be appreciated, a wall section of the component at this surface section is disposed comparatively far downstream the coolant discharge location on the hot gas side surface, again related to the main working fluid flow direction, and may thus be subject to comparatively high thermal loading. By virtue of the impinging free jet from the coolant inflow duct effective impingement cooling of said wall section is effected.

As is readily apparent to the skilled person, an extent of the near wall cooling duct across and along the main working fluid flow direction may be chosen larger than a cross sectional extent in a direction between the coolant side surface and the hot gas side surface.

The component may be provided with a multitude of individual coolant discharge ducts, in particular provided in a wall of the component and distributed along and/or across the main working fluid flow direction. One or more of the coolant discharge ducts may be provided in accordance with the disclosure above.

As will be appreciated, certain embodiments may require complex duct geometries to be provided inside the wall of the component. Said duct may not or may only expensively manufactured by chip removing methods. The component may be thus in particular be obtained by high precision casting. In further embodiments, the component may be obtained by additive production methods, such as, but not limited to, selective laser melting or selective electron beam melting.

Further disclosed is a gas turbine engine comprising a turbo-engine component as described above and/or applying the cooling method as herein disclosed.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 a sectional view of a wall of a turbo-engine component comprising a coolant arrangement as described above and suitable for performing the method according to the present teaching, exposing a longitudinal section of a coolant discharge duct;

FIG. 2 a sectional view of a first exemplary embodiment of a coolant discharge duct;

FIG. 3 a sectional view of a further exemplary embodiment of coolant discharge ducts;

FIG. 4 a further embodiment of a wall of a turbo-engine component comprising a coolant arrangement as described above and suitable for performing the method according to the present teaching and

FIG. 5 an exemplary embodiment of a turbo-engine component according to the present disclosure.

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

### EXEMPLARY MODES OF CARRYING OUT THE TEACHING OF THE PRESENT DISCLOSURE

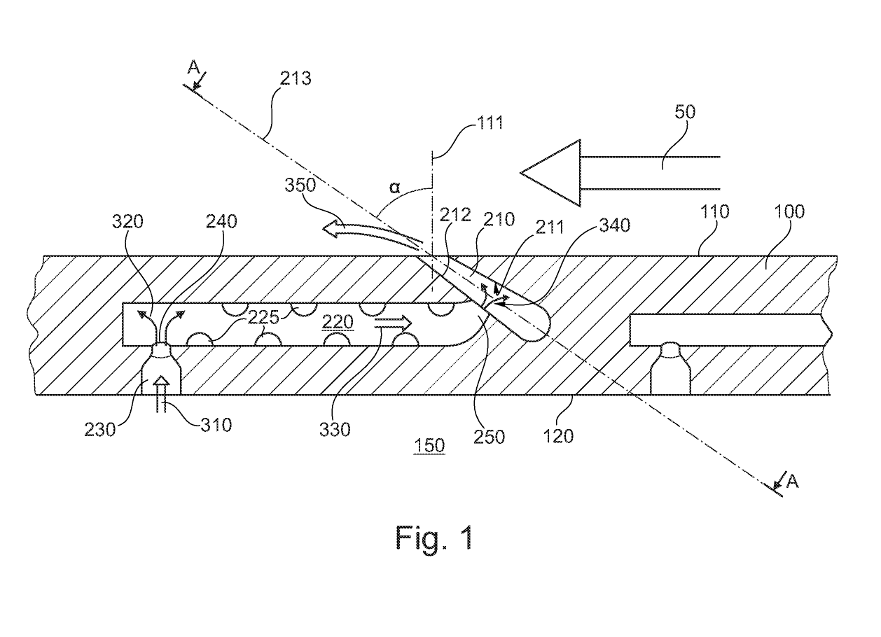

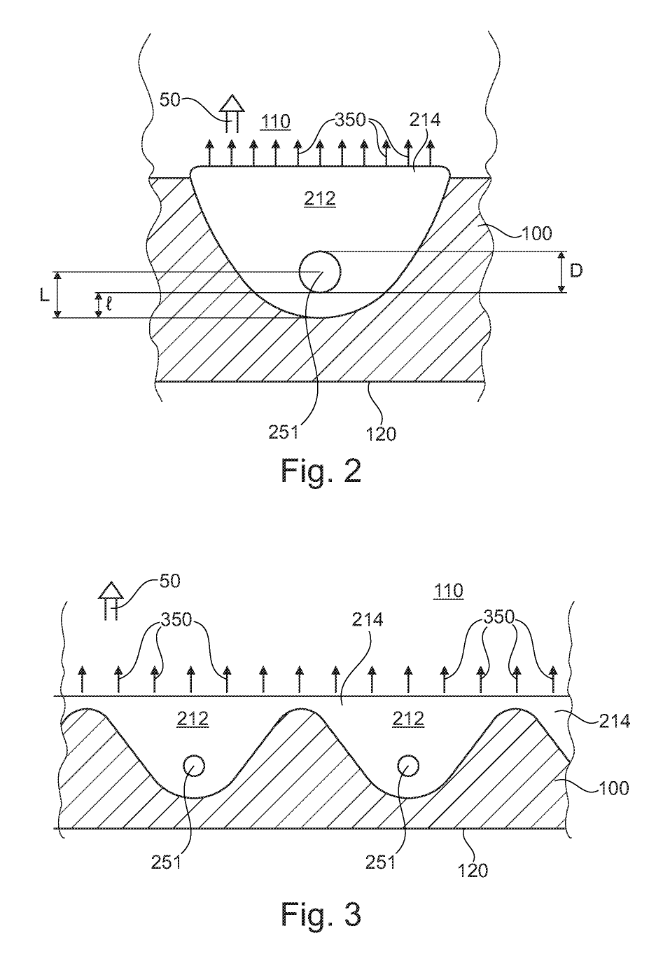

FIG. 1 shows an embodiment of a wall 100 of a turbo-engine component. The wall 100 comprises a hot gas side surface 110 and a coolant side surface 120. The hot gas side surface 110 is intended, when the component is installed in a turbo-engine, and the turbo-engine is operated, to be exposed to a working fluid flow 50. The component is in particular intended to be installed in the turbo-engine such that the working fluid flow flows along the hot gas side surface 110 of the component wall 100 in a main working fluid flow direction indicated by the arrow at 50, into a main working fluid flow downstream direction. It is to this extent possible to define an upstream and a downstream direction of the component, or the wall 100, respectively, related to the main working fluid flow direction. The working fluid flow 50 may be present at elevated temperatures, for instance in an expansion turbine of a gas turbine engine. In particular, components installed in the first stages of such an expansion turbine thus require cooling. A coolant discharge duct 210 is provided in the wall 100. Coolant discharge duct 210 is delimited by a delimiting surface provided inside the wall 100. An axis 213 of the coolant discharge duct is inclined with respect to a normal 111 of the hot gas side surface 110 at an angle a, and is slanted towards the downstream direction of the working fluid main flow when considering an orientation of the coolant discharge duct 210 from inside the wall to a discharge opening provided on the hot gas side surface. In another aspect, a first section 211 of the delimiting surface and a second section 212 of the delimiting surface are inclined with respect to the normal, and slanted towards a downstream orientation of the main working fluid flow direction. It will be appreciated, that wall 100 may be curved, and consequently the hot gas side surface 110 may be curved. It will be readily understood by the skilled person, that in this instance a local normal at a location where the fluid discharge duct opens out onto the hot gas side surface, that is, a discharge location, will be applied for the definition of said normal, or said inclination, respectively. A coolant discharge flow 350 is discharged from coolant discharge duct 210 through a coolant discharge opening provided on the hot gas side surface and is provided as a coolant layer flowing over the hot gas side surface 110, thus on the one hand removing heat from the component, or the component wall 100, respectively, and furthermore separating the hot gas side surface of the wall from the main working fluid flow 50. Due to the inclination of the coolant discharge duct 210, first surface section 211 is disposed towards the hot gas side surface, and second surface section 212 is disposed towards the coolant side surface of the wall 100, or the component, respectively. In another aspect it may be said that the first section 211 of the delimiting surface is disposed upstream while the second section 212 of the delimiting surface is disposed downstream, in each case related to the main working fluid flow direction. The coolant discharge duct is provided as a blind cavity inside the wall 100, not completely penetrating the wall from the hot gas side surface to the coolant side surface. It is closed towards the coolant side surface 120 of the wall. In order to provide a coolant to the coolant discharge duct, a coolant supply path is provided, comprising a coolant inflow duct 230 and a near wall cooling duct 220. A multitude of coolant inflow ducts may typically be provided in fluid communication with a near wall cooling duct, and in a row extending across the width of the near wall cooling duct. Near wall cooling duct 220 is disposed inside the wall 100 and runs along a lengthwise extent of the wall as defined by the main working fluid flow direction in this particular embodiment. In particular, the near wall cooling duct may be arranged to run at least essentially parallel to the hot gas side surface 110 of the wall 100. The coolant inflow duct extends from the coolant side surface 120 of the wall. It joins the near wall cooling duct at a lateral surface of the near wall cooling duct, and near a first end of the near wall cooling duct. Said first end, in the present embodiment, is a downstream end of the near wall cooling duct with respect to the main working fluid flow direction. It is an upstream end of the near wall cooling duct with respect to the near wall coolant flow direction. The near wall cooling duct 220 extends within the wall from the first end to a second end, wherein the second end is disposed upstream the first end with respect to the main working fluid flow direction. A nozzle 250 is provided adjacent the second end of the near wall cooling duct, and joins the coolant discharge duct 210 at a lateral surface thereof, namely at second or downstream surface section 212 which is disposed towards the coolant side 120 of the wall. The coolant supply path joins the coolant discharge duct at a nonzero angle, and in this particular embodiment at least essentially at a right angle. Coolant inflow duct 230 opens out onto the coolant side surface 120. Thus, the coolant supply path is in fluid communication with a coolant supply volume 150 provided adjacent the coolant side surface 120 of the wall 100. As indicated at 310, the coolant supply flow flows from the coolant supply volume 150 and into coolant inflow duct 230. At a junction with the near wall cooling duct 220, a nozzle 240 is provided. Said nozzle is not essential for the teaching of the present disclosure, but is a well-conceivable embodiment. Through nozzle 240, a coolant free jet 320 enters near wall cooling duct 220 and effects impingement cooling of a part of a delimiting surface of the near wall cooling duct which is disposed towards the hot gas side surface of the wall and is thus exposed to heat intake from the working fluid flow 50, although said heat intake is reduced by coolant flow 350 flowing over the hot gas side surface. The coolant supply flow further flows through near wall cooling duct 220 as near wall cooling flow 330 in a direction oriented from the first end of the near wall cooling duct to the second end of the near wall cooling duct. The flow direction of near wall cooling flow 330 is oriented against the main working fluid flow direction 50. Thus, counterflow cooling of the wall is effected. In order to intensify heat exchange between near wall coolant flow 330 and the delimiting surface of near wall cooling duct 220, protruding elements 225 are arranged on said delimiting surface, and act as turbulators. In addition, the turbulators enlarge the surface area which participates in heat transfer. Other means known to the skilled person which intensify heat transfer between the surfaces delimiting the near wall cooling duct and the coolant flow therethrough may be present instead of, or in addition to, the protrusions, such as, but not limited to, posts connecting opposed surfaces, the delimiting surfaces of the near wall cooling duct may be undulating, and so forth. Near wall coolant flow 330 then is discharged from the coolant supply path through nozzle 250 as a free jet 340 and into coolant discharge duct 210. Free jet 340 impinges on the first surface section 211 of a delimiting surface which delimits the coolant discharge duct and effects impingement cooling of said surface, and accordingly a related section of the wall 100. The coolant discharged into coolant discharge duct 210 through free jet 340 is subsequently discharged as coolant discharge flow 350 at the hot gas side surface 110 of the wall 100, and forms a film cooling flow as described above. In providing nozzles 250 and 240, and thus a continuous acceleration of the flow therethrough to form the free jets, more defined and unidirectional free jet flows are achieved, when compared to simple orifices, thus enhancing impingement cooling efficiency. It is noted that nozzle 250 joins the coolant discharge duct 210 at a certain distance from the blind end, or upstream end with respect to the coolant discharge flow direction, of the coolant discharge duct 210. This will be lined out in more detail in connection with FIG. 2. This enables free jet 340 to more uniformly disseminate over first section 211 of the delimiting surface of the coolant discharge duct. Likewise, and for the same reason, it is noted that coolant inflow duct 230, or nozzle 240, respectively joins the near wall cooling duct 220 at a certain distance from the first, blind and of the near wall cooling duct 220.

It will be appreciated, that the flow of coolant, before it is discharged through coolant discharge duct 210, serves to cool an extended area of the wall 100. In particular, cooling is applied to surface areas of coolant ducts which are disposed towards the hot gas side surface 110, and thus to sections of the wall 100 which are exposed to a major heat intake from the working fluid flow 50. It will further be appreciated that the cooling becomes effective over a considerable longitudinal extent of the wall along the main working fluid flow direction. As can further be seen in FIG. 1, a further coolant inflow duct and near wall cooling duct may be provided adjacent the coolant discharge duct 210, and upstream thereof, with respect to the main working fluid flow direction, and may in a manner not shown in the present depiction, but which is apparent to the skilled person, be in fluid communication with a further coolant discharge duct. Thus, essentially the entire extent of the wall 100 may be provided with cooling features, and a more homogeneous temperature distribution within the wall 100 may be achieved. Moreover, effective cooling of a portion of the wall 100 bearing the first section of the coolant discharge duct delimiting surface and where a low material thickness is provided, is effected due to impingement cooling of said coolant discharge duct delimiting surface section.

FIG. 2 shows a sectional view along A-A in FIG. 1 in a first embodiment. While it is visible in connection with FIG. 1 that the fluid discharge duct 210 converges when considering an orientation of the coolant discharge duct from within the wall towards the discharge opening 214 provided on the hot gas side surface 110 of the wall 100 in a longitudinal section of the wall, in this cross-sectional aspect the coolant discharge duct diverges when considering the same orientation. A coolant discharge opening 214 assumes the shape of a slot, with the longitudinal orientation of the slot extending across the direction of the working fluid flow 50. Coolant discharge flow 350 thus is provided as a layer of coolant extending across the main working fluid flow direction. The coolant supply path joins the coolant discharge duct through coolant supply opening 251 provided on the second inner surface section 212 of the coolant discharge duct. Coolant discharge opening 251 has a size D in the coolant flow direction, or, in this instance, a diameter D. A lower or upstream edge is spaced from the blind or upstream end of the coolant discharge duct by a distance I, which is in certain embodiments larger than or equal to 50% of the size D, and in still further embodiments larger than or equal to 70% of the size D. In another aspect, a center of the coolant supply opening 251, when seen along the coolant flow direction, is spaced apart from the blind or upstream end of the coolant discharge duct by a distance L which is larger than or equal to D, and is more particularly larger than or equal to 1.2 D.

FIG. 3 shows a sectional view along A-A in FIG. 1 in a second embodiment. Again, a cross-sectional view of the component, or the wall 100, respectively, is shown, providing a plan view on second sections 212 of inner surfaces which delimit coolant discharge ducts. Individual coolant discharge ducts are arranged adjacent each other in a direction across the main working fluid flow direction 50. The individual coolant discharge ducts are shaped in this cross-sectional view, and are arranged, such that they join each other at the hot gas side surface 110 of the wall 100. One common coolant discharge slot 214 is provided on the hot gas side surface 110 for the coolant discharge ducts arranged in one cross-section of the wall. Thus, a largely homogeneous layer of discharged coolant 350 is provided on the hot gas side surface 110. Coolant is supplied to the coolant discharge ducts through individual coolant supply openings 251 in the second section of the inner delimiting surface of a respective coolant discharge duct. As lined out in connection with FIG. 1, a nozzle is provided in the coolant supply path upstream the coolant supply openings 251, wherein upstream in this instance relates to the direction of the coolant supply flow, such as to accelerate the coolant supply flow before it enters a coolant discharge duct, and to discharge the coolant supply flow as a free jet into the coolant discharge ducts. As lined out in connection with FIG. 1, the free jets discharged from coolant supply openings 251 are provided for impingement cooling of a first section of an inner surface of a coolant discharge duct which is arranged opposite surface section 212, and which delimits the coolant discharge duct towards the hot gas side surface of the wall. While said first inner surface section is not visible in the present cross-sectional view, it has been lined out in detail in connection with FIG. 1.

It should be noted and be readily appreciated that, while in the above exemplary embodiments the teaching of the present document has been explained in connection with specific geometries of coolant discharge ducts, the teaching according to the present disclosure may be used in connection with any kind of coolant discharge duct which does in particular not penetrate the wall. For instance, cylindrical, conical, or any kind of fan-shaped or generally contoured blind cavities may be applied as coolant discharge ducts.

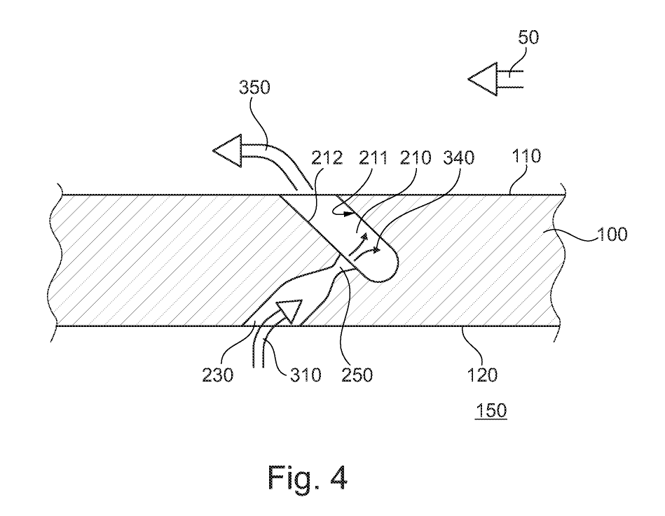

FIG. 4 shows an exemplary less sophisticated embodiment which makes use of the teaching as disclosed herein. A non-penetrating coolant discharge duct 210, that is, a blind cavity which is closed towards the coolant side surface 120 of the wall 100, and which opens out onto the hot gas side surface 110 of the wall, is provided in said wall 100. As in the embodiments illustrated in connection with FIGS. 1 through 3, the coolant discharge duct is inclined in the direction of the main working fluid flow direction 50, such that a coolant discharge flow 350 has a velocity component directed into the direction of the main working fluid flow. Thus, coolant discharged at a coolant discharge opening provided at the hot gas side surface 110 of the wall forms a film cooling layer on the hot gas side surface downstream the coolant discharge opening. Coolant inflow duct 230 is open on the coolant side surface 120 of the wall, and is in fluid communication with a coolant supply volume 150 provided adjacent the coolant side surface 120. A coolant supply flow 310, which is supplied to the coolant inflow duct, is accelerated in nozzle 250, and is discharged through an opening provided in a second section 212 of a delimiting surface of the coolant discharge duct 210, and into the coolant discharge duct. Thereby, it forms a free jet 340 directed towards a first section of the delimiting surface which delimits the coolant discharge duct, and effects impingement cooling of said first surface section. Similar to the embodiments lined out above, the first section of the delimiting surface of the coolant discharge duct is disposed towards the hot gas side surface 110 of the wall 100, and the second section 212 of the delimiting surface of the coolant discharge duct 210 is disposed towards the coolant side surface 120. Thus, again the surface section of the delimiting surface which is exposed to a higher heat intake is impingement cooled by free jet 340, and benefits from the impingement cooling provided by nozzle 250 and the free jet 340 emanating from the nozzle.

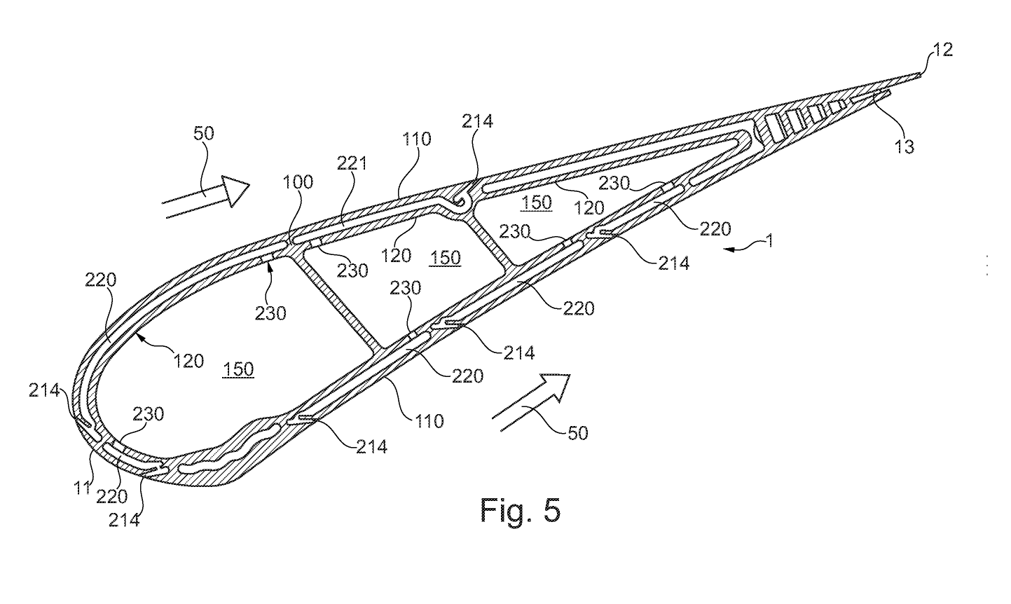

An exemplary embodiment of a turbine airfoil 1 is shown in FIG. 5, as an embodiment of a turbo-engine component according to the present disclosure. The airfoil 1 comprises a leading edge 11 and a trailing edge 12. A suction side and a pressure side are arranged between the leading edge and the trailing edge. A working fluid flow 50 flows around the airfoil, from the leading edge to the trailing edge, and along the pressure side and the section side. A trailing edge coolant slot 13 is provided at the trailing edge in a known manner. A wall 100 of the airfoil encloses coolant supply volumes 150 provided inside the airfoil, and being delimited by coolant side surfaces 120 of the wall 100. A hot gas side surface 110 of the wall is exposed to the working fluid flow 50. The wall 100 is equipped with a multitude of coolant discharge ducts (without reference numbers in this figure) which open out onto the hot gas side surface at coolant discharge openings 214. Each coolant discharge duct is in fluid communication with either a counterflow near wall cooling channel 220, or a parallel flow near wall cooling duct 221. Each near wall cooling duct is in fluid communication with a coolant supply volume 150 through a coolant inflow duct 230.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

1 turboengine component, airfoil
11 leading edge
12 trailing edge
13 trailing edge cooling slot
50 working fluid flow; main working fluid flow direction
100 wall of a turboengine component
110 hot gas side surface
111 normal of the hot gas side surface
120 coolant side surface
150 coolant supply volume
210 coolant discharge duct
211 first section of an inner surface delimiting the coolant discharge duct
212 second section of an inner surface delimiting the coolant discharge duct
213 axis of the coolant discharge duct
214 coolant discharge opening, coolant discharge slot
220 near wall cooling duct
221 parallel flow near wall cooling duct
225 protruding elements, turbulators, turbulence generating elements
230 coolant inflow duct
240 nozzle
250 nozzle
251 coolant supply opening
310 coolant supply flow
320 coolant free jet
330 near wall coolant flow
340 coolant free jet
350 coolant discharge flow
a angle
D size of the coolant supply opening and/or free jet generating means along the coolant flow direction inside the coolant discharge duct; diameter of the coolant supply opening and/or free jet generating means
I distance from a blind end of the coolant discharge duct to a downstream edge of the coolant supply opening and/or free jet generating means
L distance from a blind end of the coolant discharge duct to a center of the coolant supply opening and/or free jet generating means

1. A method for cooling a turbo-engine component, the method comprising:
guiding a working fluid flow along a hot gas side surface of a wall of the component and in a main working fluid flow direction,
discharging a coolant discharge flow at the hot gas side surface from a coolant discharge duct provided in the wall,
supplying a coolant supply flow to the coolant discharge duct and through a coolant supply path,
discharging the coolant supply flow into the coolant discharge duct as a free jet oriented across a cross section of the coolant discharge duct, and
directing the free jet onto an inner surface section of the coolant discharge duct, thus effecting impingement cooling of the inner surface section.

2. The method according to claim 1, comprising:
guiding the coolant supply flow through a means for generating a free jet and discharging the free jet from said means for generating.

3. The method according to claim 1, comprising:
discharging the coolant discharge flow in a direction inclined with respect to a normal of the hot gas side surface at: discharge location, whereby the coolant discharge duct is inclined with respect to said normal thus having a first inner surface section disposed towards the hot gas side surface of the wall, and directing the free jet onto said first inner surface section.

4. The method according to claim 1, comprising:
guiding the coolant supply flow, before discharging it into the coolant discharge duct, inside a wall between a coolant side surface and the hot gas side surface, and oriented against the main working fluid flow direction and along a flow path length exceeding a wall thickness provided between the coolant side surface and the hot gas side surface, such as to perform counterflow near wall cooling of the wall, wherein the flow path of the coolant supply flow is at least essentially parallel to the hot gas side surface.

5. The method according to claim 1, wherein the turbo-engine component comprises;
the wall having a hot gas side surface and a coolant side surface;
the at least one coolant discharge duct provided in said wall and opening out onto the hot gas side surface; and
the coolant supply path in fluid communication with the coolant discharge duct, wherein the coolant discharge duct and the coolant supply path are configured and arranged to discharge the coolant supply flow as a free jet oriented across the cross section of the coolant discharge duct and onto the inner surface section of the coolant discharge duct.

6. A turbo-engine component comprising:
a wall, the wall having a hot gas side surface and a coolant side surface;
at least one coolant discharge duct provided in said wall and opening out onto the hot gas side surface, the coolant discharge duct being delimited by an inner surface thereof;
a coolant supply path provided in the wall and in fluid communication with the coolant discharge duct, wherein the coolant supply path joins the coolant discharge duct at a lateral delimiting surface thereof at a nonzero angle; and
a means for providing a free jet emanating from the coolant supply path and into the coolant discharge duct.

7. The turbo-engine component according to claim 6, wherein the coolant discharge duct is a blind cavity and is closed towards the coolant side surface.

8. The turbo-engine component according to claim 6, wherein the coolant supply path joins the coolant discharge duct through an opening provided in a lateral delimiting surface section thereof disposed on a downstream side with respect to a main working fluid flow direction.

9. The turbo-engine component according to claim 6, wherein the coolant discharge duct is inclined with respect a normal of the hot gas side surface at a first angle, said inclination being directed downstream a main working fluid flow direction of the component when considering an orientation of the coolant discharge duct from inside the wall to a discharge opening provided on the hot gas surface, such that a lateral delimiting surface comprises:
a first surface section disposed towards the hot gas side surface of the wall and a second surface section disposed towards the coolant side surface of the wall, and wherein the coolant supply path joins the coolant discharge duct through an opening provided in the second surface section.

10. The turbo-engine component according to claim 6, wherein the coolant supply path comprises:
a nozzle provided at the junction with the coolant discharge duct.

11. The turbo-engine component according to claim 6, wherein the coolant supply path is in fluid communication with a coolant supply volume provided adjacent the coolant side surface.

12. The turbo-engine component according to claim 6, wherein the coolant supply path comprises:
a near wall cooling duct running inside the wall along a lengthwise extent of the wall, said near wall cooling duct extending from a first end thereof to a second end thereof, wherein the means for providing a free jet is disposed adjacent the second end of the near wall cooling duct, and the first end thereof is disposed downstream of the second end of the near wall cooling duct with respect to the main working fluid flow direction.

13. The turbo-engine component according to claim 12, wherein turbulence generating elements are provided within the near wall cooling duct.

14. The turbo-engine component according to claim 12, wherein a coolant inflow duct is provided extending between the coolant side surface of the wall and the near wall cooling duct and joins the near wall cooling duct at a sidewall thereof, wherein the junction is provided adjacent the first end of the near wall cooling duct and is provided on a side of the near wall cooling duct disposed towards the coolant side.

15. The turbo-engine component according to claim 6, in combination with a gas turbine engine.
